(19) United States
(12) Patent Application Publication
(10) Pub. No.: US 2014/0129003 A1
(43) Pub. Date: May 8, 2014

(54) SYSTEM FOR PROVIDING MAPPABLE INPUT AND OUTPUT TERMINAL ASSIGNMENTS

(71) Applicant: HONYWELL INTERNATIONAL INC., Morristown, NJ (US)

(72) Inventors: Ralph C. Brindle, Edina, MN (US); Aaron F. D'Souza, Morristown, NJ (US); Paul C. Wacker, Plymouth, MN (US); Stalin Gutha, Bangalore (IN)

(73) Assignee: HONEYWELL INTERNATIONAL INC., Morristown, NJ (US)

(21) Appl. No.: 13/668,153

(22) Filed: Nov. 2, 2012

(51) Int. Cl. G05B 15/02; G05B 11/01

(52) U.S. Cl. 700/83; 700/276

(57) ABSTRACT

A controller having logical inputs and outputs and physical options for input and output connections that may be determined at the time that the controller is shipped from a factory. However, after release of the controller from the factory, an end user may have the flexibility to map logical inputs and outputs to physical inputs and outputs, respectively, in any manner as desired. This flexibility may result in optimal use of a limited number of input/output terminals and any available network variables to reduce controller complexity and costs.

### BACKGROUND

The present disclosure pertains to controllers and particularly to configurable controllers.

### SUMMARY

The disclosure reveals a controller having physical options for input and output connections and logical inputs and outputs that may be determined by the time that the controller is shipped from a factory. However, after release of the controller from the factory, an end user may have the flexibility to map logical inputs and outputs to physical inputs and outputs, respectively, in any manner as desired. This flexibility may result in optimal use of a limited number of input/output terminals and any available network variables to reduce controller complexity and costs.

### BRIEF DESCRIPTION OF THE DRAWINGS

FIG. 1 is a diagram that relates to a direct public variable reference and shows an example of how a public variable reference may be dereferenced without use of the present system;

FIGS. 2 and 3 are diagrams of a logical input public variable reference and illustrate how a reference to a logical input public variable identifier may be dereferenced to locate an actual value to be read or written;

FIGS. 4 and 5 are diagrams of a logical output public variable reference and illustrate how a reference to a logical output public variable identifier may be dereferenced to locate the actual value to be read or written; and

FIGS. 6 and 7 are diagrams of two installations to indicate an application of the present system utilizing the flexibility of logical input and output maps to serve differing installations from the same controller after the system is released from the factory.

### DESCRIPTION

The present system and approach, as described herein and/or shown in the Figures, may incorporate one or more processors, computers, controllers, user interfaces, wireless and/or wire connections, and/or the like, wherever desired.

Controllers with a fixed set of configurable behaviors may be popular for their ease of use and predictable performance. Such controllers may serve the customer best when they can be configured to operate with a wide variety of external sensors and actuators, connected to a wide variety of selectable features. If separate terminals are provided for all possible types of input or output features to be supported, the controller may suffer the cost of all those terminals, many of which will go unused for any particular installation environment.

For example, an HVAC controller may be sure to offer temperature sensing of the space being controlled, but might also offer improved performance or diagnostics if a discharge air temperature sensor or outdoor air temperature sensor is available. One may say that there are twelve such input offerings of an optional nature. If only six of them are likely to be used on a given installation, it would appear to be a waste of product cost to supply all twelve terminals.

On the output side, there may be selections for several stages of heating and cooling, reheat and humidification/dehumidification that number around ten, but only five might be chosen on a given installation.

Now one may take the situation one step further to include the possibility of network variables (NVs) on connected communications networks as participants as sources of input information or destinations of output information. When a network is available, it may supplant the use of a terminal altogether.

What is desired may be a means of using a minimum set of terminals whose connection to a feature can be defined by the user, rather than by the hardware.

In response, the present system may use a concept of a logical input or logical output that is manipulated by the controller independent of its assignment to a terminal. The mapping to terminals may be accomplished by writing to configuration network variables associated with each logical input or output to determine its terminal assignment. When the controller reads a logical input, the read request may be routed through a mapping layer to get the data from the desired input terminal. When the controller writes to a logical output, the write request may be routed through a mapping layer to reach the desired output terminal.

Previously, this level of flexibility appeared to be available only in programmable controllers, where the entire application could be modified to change the terminal connections used. With the present system, even configurable controllers with a pre-built control program may benefit from assignment of terminals performed in the field.

The present system may foster and support the development of standard control applications. Since an application may deal with logical inputs and outputs, a feature is that it can be reused in other hardware environments, with different numbers of inputs and outputs available. No modification of the original control application is necessarily needed.

Related art controllers may utilize a system of “public variables” to support data sources and destinations of all kinds, be they hardware terminal or communication network related. Internal to the controller, virtually all data transfers may occur via read or write of a public variable. The present system may build upon the public variable system, so a bit of background appears in order to understand the terms public variable (PV) and public variable identifier (PVID).

A PVID may represent a scalar piece of information of interest to the system in which the controller resides. Internal to the controller, the PVID can be used to read or write the value of the associated PV. In the case of a configurable (not fully programmable) controller, the meaning of each PVID may be determined at the time the controller is shipped.

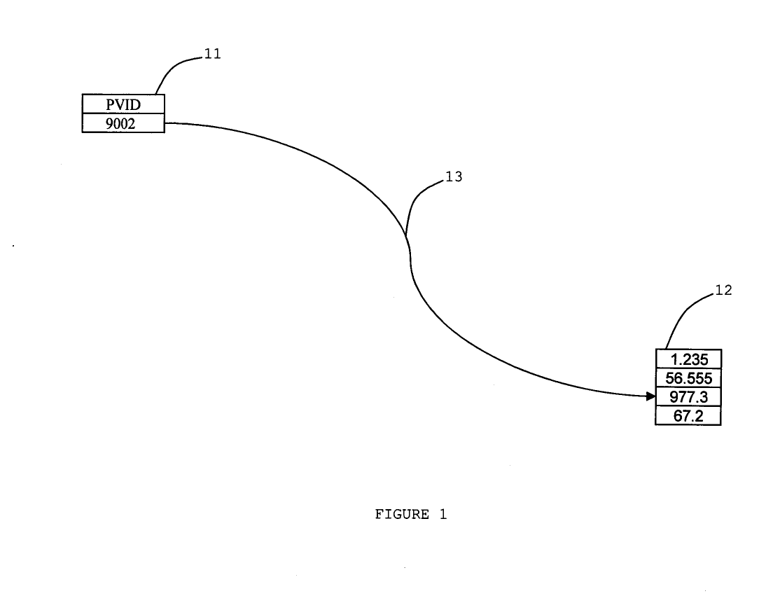

The diagram “Direct Public Variable Reference” of FIG. 1 illustrates how a PVID may typically be decoded using upper bits to identify a subset of public variables, and lower bits to identify a particular scalar value member of that subset.

The present system may add a new set of public variables to represent logical inputs. Because a source of its data is determined at run time, a logical input variable may have an identifier, but no storage associated with it. The logical input may be supported by two sets of public variables which do have storage associated with them. One set may be the physical input public variables, whose storage is a configuration table containing an indirect reference to the “traditional” public variable associated with the source of the data. One may think of this as a list of all the possible options for sources of data for all the logical inputs on the controller. Another set may be the logical input map public variables, representing the nonvolatile value selecting the source of each logical input. The values stored in the logical input map may be indices into the physical input configuration table. One may think of them as chosen from a global enumeration of possible physical input sources for all logical inputs available on the controller, each physical input source having a unique physical input enumeration value. The source of information feeding a logical input may be an input terminal on the controller, a field of a network variable, or an intermediate variable in the control application residing on the controller.

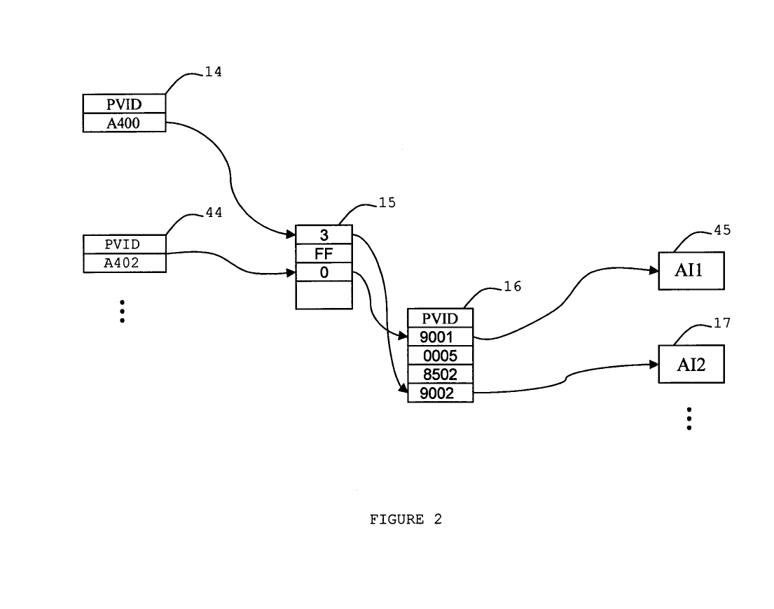

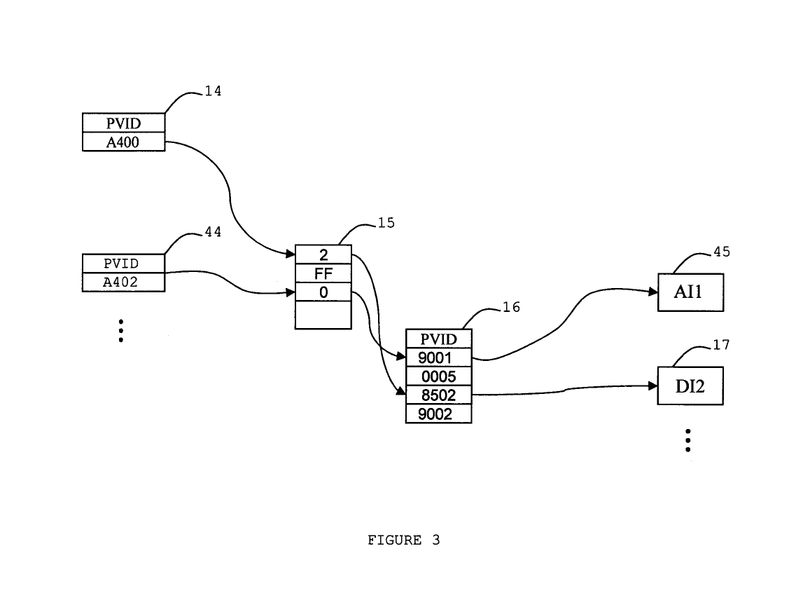

The diagrams of FIG. 2 and FIG. 3 illustrate how a reference to a logical input PVID is dereferenced to locate the actual value to be read or written. Again, the upper bits of the PVID may identify the subset of PVs as the logical inputs, and the lower bits may provide an index within the subset.

Similarly, a new set of logical output variables may be created, along with a set of physical output public variables representing the possible destinations for all physical outputs on the controller, and a set of nonvolatile logical output map public variables used to select the destination for each logical output from among the possible physical outputs available.

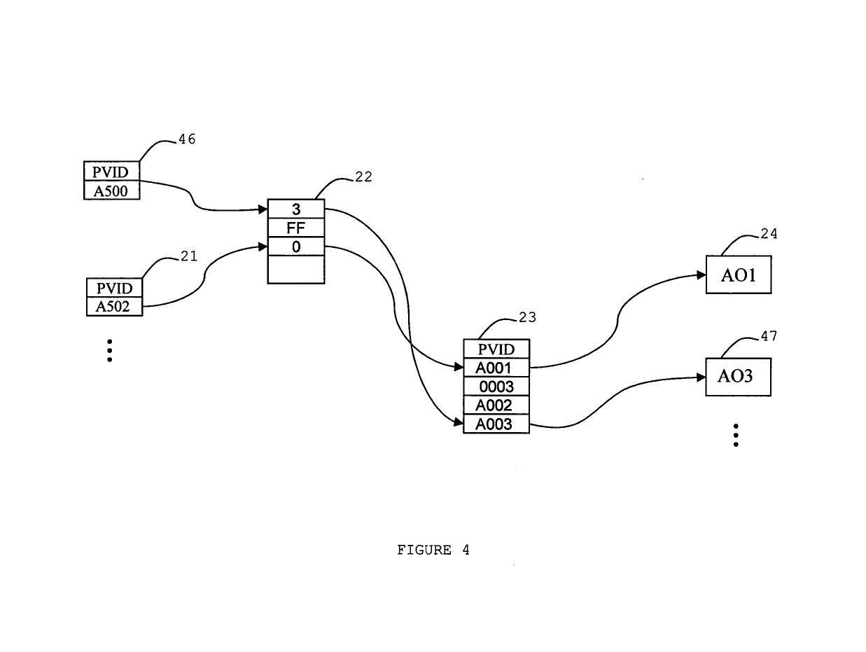

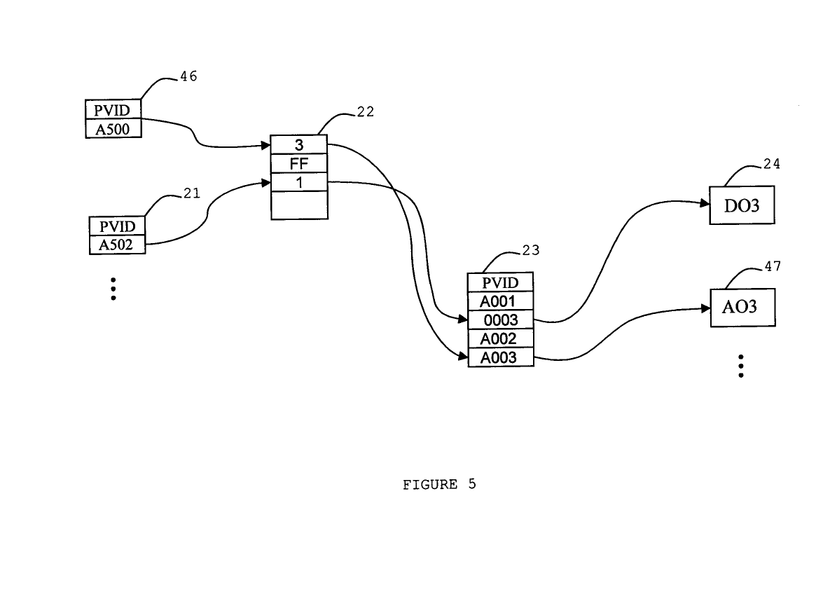

The diagrams of FIG. 4 and FIG. 5 illustrate how a reference to a logical output PVID is dereferenced to locate the actual value to be read or written. Again, the upper bits of the PVID may identify the subset of public variables as the logical outputs, and the lower bits provide an index within the subset.

In order to support writing the content of the logical input map and logical output map, they each have a public variable subset (the logical input map public variables and the logical output map public variables). Note the difference between accessing a logical input public variable, with indirection via the logical input map, and accessing a logical input “map” public variable, to read or write the content of the logical input map itself.

Given a software implementation that already supports the concept of public variable access, the present system may need a minor additional investment in code. The addition of six new subsets of public variables may be needed, but may not necessarily be complex. The indirection needed to dereference a logical PVID appears straightforward to implement.

A kernel and significance of the present system is that the physical options for input (output) connection and the logical inputs (outputs) may be determined at the time the controller is shipped. Yet the end user may have full flexibility to map the logical inputs (outputs) to physical inputs (outputs) in any way he/she chooses. This is what gives the controller the safe, predictable operation of a configurable controller, with the application flexibility of a programmable controller. This flexibility in turn may make optimal use of limited I/O terminals and any available network variables to reduce controller cost.

The present system may provide flexibility to choose the physical source of a logical input or the physical destination of a logical output in a fixed application (configurable controller) environment where the logical inputs/outputs and the physical input/output connection options are determined by the application prior to shipping the product.

FIG. 1 is a diagram that relates to a direct public variable reference 11. The diagram is an example of how a public variable reference is normally dereferenced without use of the present system. The reference may be used to either read or write a public variable. In this case, if a read is invoked, the value returned may be 973.3. If a write is invoked, the value written may replace 977.3 in an analog input store array 12. Arrow 13 may indicate the item of dereference.

The upper bits of the PVID may identify a subset of all public variables, in this case, the analog inputs. The lower bits may act as an index within that subset. Typically, the index may be treated as an index into a storage array; but the access may be function-based, so any implementation can be used.

FIG. 2 is a diagram showing a logical input public variable reference 14 (A400), which may represent an outdoor air temperature (OAT) in a present application. To read or write a logical input public variable, the variable may be dereferenced via a logical input map 15. The least significant bits of the logical input PVID A400 (00) may be used as an index into the logical input map 15 to obtain a map value “3”. The value, for example “3”, in logical input map 15 may be taken as an index to a PVID 9002 at the physical inputs table 16. In other words, a PVID from physical inputs table 16 may represent an actual public variable storage to be accessed, which can be in this case 9002, representing, for instance, an analog input channel number 2 (AI2) at item 17.

Another reference 44 can identify, for instance, a logical input 2, represented by PVID A402, which may represent a parameter in the present application. To read or write a logical input public variable, the variable may be dereferenced by using the least significant bits (02) as an index into the logical input map 15. A value “0” in logical input map 15 may be taken as an index into the physical inputs table 16. A PVID from physical inputs table 16 may represent an actual public variable storage to be accessed, which would be in this case 9001, representing, for instance, an analog input channel number 1 (AI1) at item 45. There may be one or more additional references which may represent one or more parameters in the same manner as the others noted herein.

Physical inputs table 16 may represent virtually all options for mapping of logical inputs. The options may be determined prior to shipping a product with the present system. Logical input map 15 may house user selections for a mapping of the physical PVID 14 to logical inputs table 16. It may be written by a user after the product incorporating the system is in the field. A physical input may be an AI2 at item 17. However, the value “3” at the top of map 15 may be changed to a “2” which changes the reference to a different physical input item 8502 at table 16 and DI2 instead of A12 at item 17.

FIG. 4 is a diagram of a logical output public variable reference, PVID A502 at item 21, which can represent a commanded damper position in the application. To read or write the logical output PV, the least significant bits of the logical output PVID A502 (02) may be used as an index into the logical output map 22 to obtain a value “0”. The value in the logical output map may be taken as an index “0” to a PVID A001 of physical outputs table 23. A PVID from the physical outputs table may represent the actual public variable storage to be accessed which in this case would be A001, representing an analog output channel number 1 (AO1). Physical outputs table 23 may represent virtually all options for mapping of logical outputs. Table 23 may be determined prior to shipping the product incorporating the present system. Logical output map 22 may house user selections for a mapping of physical outputs to logical outputs. Map 22 may be written or changed by a user after the product is in the field. A physical output AO1 at item 24 may result from PVID A001 of physical outputs table 23.

Another reference 46 (PVID A500) may identify a logical output which may represent, for example, a drive signal for a piece of equipment. Reference 46 may indicate a value “3” at map 22 that may be an index which leads to a PVID A003 in physical outputs table 23. A physical output AO3 in item 47 may result from PVID A003 in table 23. There may be one or more references which may represent one or more parameters in the same manner as the others noted herein.

In FIG. 5, the index “0” in map 22 may be changed to a “1” by a user, which may result in a reference to PVID 0003 of physical outputs table 23, and ultimately, a change in reference from AO1 to DO3 at item 24.

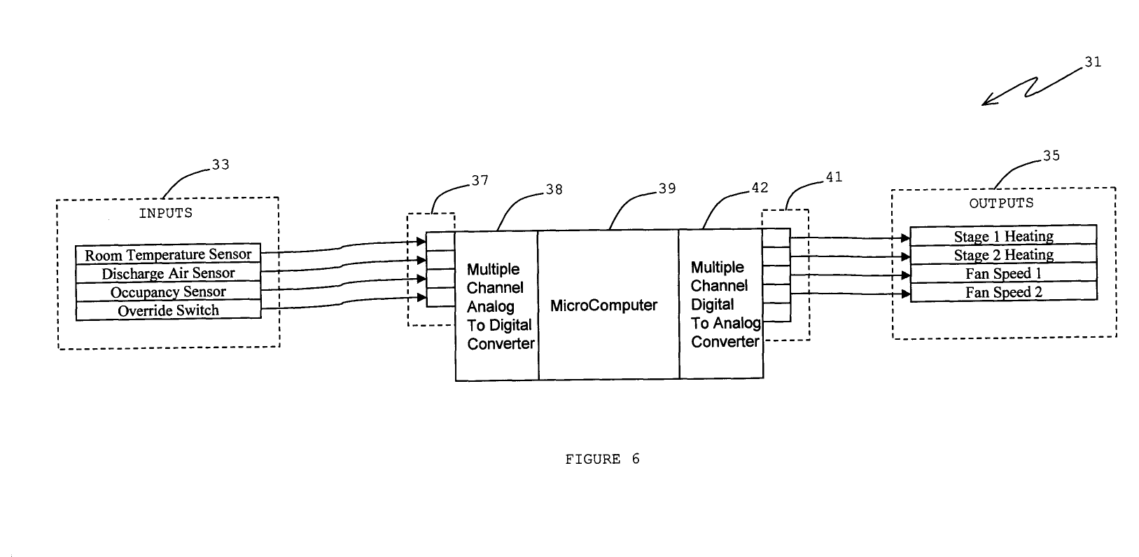

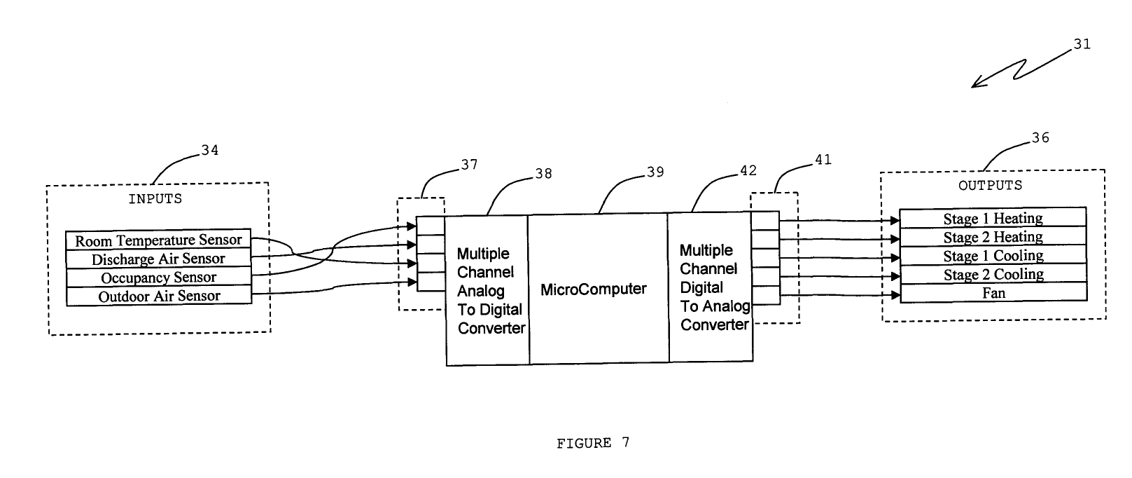

FIG. 6 is a diagram of an installation 31 and FIG. 7 is a diagram of an installation 32. In a logical input/output context installation 32 shows inputs 34 and outputs 36 different than the inputs 33 and outputs 35 of installation 31. Installations 31 and 32 indicate an application of the present system utilizing logical input and output maps having a flexibility of changeable relationships of logical inputs and outputs to their physical sources and destinations, respectively. These relationships may be changed by a user in the field or other place after the system is released from the factory.

At installation 31, a room temperature sensor, discharge air sensor, occupancy sensor an override switch of inputs 33 may be connected to terminals 1, 2, 3 and 4, respectively, of an input 37 of a multiple channel ADC 38 to an input side of a microcomputer 39. At installation 32, a room temperature sensor, discharge air sensor, occupancy sensor and an outdoor air sensor of inputs 34 may be connected to terminals 3, 2, 1 and 4, respectively, on input 37 of the multiple channel ADC 38 to the input side of microcomputer 39. A change in connections of the temperature sensor from terminal 1 to terminal 3 and of the occupancy sensor from terminal 3 to terminal 1 may be accomplished by a change of the corresponding content of the logical input map 15 (FIG. 2). Also, terminal 4 is changed from an input from an outdoor air sensor to an input from an override switch, also as a result of a user initiated change to logical input map 15.

At installation 31, a stage 1 heating, stage 2 heating, fan speed 1 and fan speed 2 of output 35 may be connected terminals 1, 2, 3 and 4, respectively, of an output 41 of a multiple channel DAC 42 of microcomputer 39. At installation 32, a stage 1 heating, a stage 2 heating, a stage 1 cooling, a stage 2 cooling and a fan of outputs 36 may be connected to terminals 1, 2, 3, 4 and 5, respectively, of output 41 of the multiple channel DAC 42 to the output side of microcomputer 39. A change in connections of terminals 3 and 4 from fan speed 1 and fan speed 2 to stage 1 cooling and stage 2 cooling may be accomplished by a change of the corresponding content of the logical output map 22 (FIG. 3). Also a terminal 5 may be incorporated for an output to a fan, also as a result of a user initiated change to logical output map 22.

In review, a same configurable HVAC control application with microcomputer may serve both installations 31 and 32 without more than 4 input and 5 output terminals. This same number of terminals may be sufficient for other installations. The types of inputs and outputs may be changed from one installation to another to match a configuration (not shown) provided to microcomputer 39. A terminal used for a given input or output function, for instance, the room temperature sensor, may be changed from one installation to another one for wiring convenience.

To recap, a heating, ventilation and air conditioning (HVAC) controller system having mappable inputs and outputs, may incorporate an HVAC controller; a logical input set of one or more logical input public variable identifiers (PVIDs), each logical input PVID representing one or more parameters, respectively, and each PVID having an index; a logical input map incorporating a table of one or more values, each value corresponding to an index of a logical input PVID, respectively; a physical inputs table incorporating one or more physical input PVIDs, each physical input PVID represented by a unique physical input enumeration value that can be placed in the logical input map; a logical output set of one or more logical output PVIDs, each logical output PVID representing one or more parameters, respectively, and each PVID having an index; a logical output map incorporating a table of one or more values, each value corresponding to an index of a logical output PVID, respectively; and a physical outputs table incorporating one or more physical output PVIDs, each physical output PVID represented by a unique physical output enumeration value that can be placed in the logical output map.

The sets, maps and/or tables may be accessible by the HVAC controller. The one or more values of the logical input map may be changeable by a user via the controller. The one or more values of the logical output map may be changeable by a user via the controller.

A source of a logical input may be an input terminal on the controller, a field of a network variable or an intermediate variable in a control application residing on the controller. A destination of a logical output may be an output terminal on the controller, a field of a network variable or an intermediate variable in a control application residing on the controller.

The set of one or more logical input PVIDs that represent one or more parameter inputs may be fixed or unchangeable. The one or more physical input PVIDs associated with the one or more physical inputs may be fixed or unchangeable. The set of the one or more logical output PVIDs that represent one or more output signals may be fixed or unchangeable. The one or more physical output PVIDs associated with the one or more physical outputs may be fixed or unchangeable.

An approach for providing a controller system having mappable inputs and outputs, may incorporate developing a logical input set of one or more logical input public variable identifiers (PVIDs) having one or more logical input PVIDs representing one or more input parameters, respectively, developing a logical input map having one or more values corresponding to the one or more logical input PVIDs, respectively, developing a physical inputs table having one or more physical input PVIDs, each with a unique physical input enumeration value suitable for placement in the logical input map, providing a controller, placing the logical input set, the logical input map and/or the physical inputs table into a memory of the controller, and operating the controller to change, as desired, the one or more values of the logical input map corresponding to the one or more logical input PVIDs, respectively.

The approach may further incorporate developing a logical output set of one or more logical output public variable identifiers (PVIDs) having one or more logical output PVIDs representing one or more output signals, respectively, developing a logical output map having one or more values corresponding to the one or more logical output PVIDs, respectively, developing a physical outputs table having one or more physical output PVIDs, each with a unique physical output enumeration value suitable for placement in the logical output map, respectively, placing the logical output set, the logical output map and/or the physical outputs table into the memory of the controller, and operating the controller to change, as desired, the one or more values of the logical output map corresponding to the one or more logical output PVIDs, respectively.

The logical input set may be unchangeable with respect to the one or more logical input PVIDs representing one or more input parameters. The logical output set may be unchangeable with respect to the one or more logical output PVIDs representing one or more output parameters. The physical inputs table may be unchangeable with respect to the one or more physical input PVIDs corresponding to the one or more values of the logical input map. The physical outputs table may be unchangeable with respect to the one or more physical output PVIDs corresponding to the one or more values of the logical output map.

The physical inputs table may be set at a factory that produces the table. The logical input set may be set at the factory that produces the set. The physical outputs table may be set at a factory that produces the table. The logical output set is set at the factory that produces the set.

The logical input map may be capable of being changed after leaving the factory that produces the map. The logical output map may be capable of being changed after leaving the factory that produces the map.

Operating the controller to change the one or more values of the logical input map relative to the corresponding one or more logical input PVIDs, respectively, may be facilitated with a tool that provides a user plain language directions and/or options so as to change the one or more values of the logical input map corresponding to one or more logical input PVIDs, respectively.

Operating the controller to change the one or more values of the logical output map relative to the corresponding one or more logical output PVIDs, respectively, may be facilitated with a tool that provides a user plain language directions and/or options so as to change the one or more values of the logical output map relative to the corresponding one or more logical output PVIDs, respectively.

A controller system having mappable inputs and outputs, may incorporate a logical input public variable identifier (PVID) set, a logical input map associated with the logical input PVID set, a physical inputs table associated with the logical input map and one or more physical inputs, and a controller having a memory that may incorporate the logical input PVID set, the logical input map and/or the physical inputs table. One or more values of the logical input map, corresponding to one or more logical input PVIDs of the logical input PVID set, respectively, may be changeable by a user.

The system may further incorporate a logical output PVID set, a logical output map associated with the logical output PVID set, and a physical outputs table associated with the logical output map and one or more physical outputs, respectively. The memory may incorporate the logical output PVID set, the logical output map and/or the physical outputs table. The one or more values of the logical output map, corresponding to one or more physical output PVIDs of the physical output map, respectively, may be changeable by the user.

The logical input PVID set may incorporate one or more logical input PVIDs representing one or more input parameters, respectively. The logical input map may incorporate one or more unique physical input enumeration values corresponding to the one or more physical input PVIDs, respectively. The physical inputs table may incorporate one or more physical input PVIDs, each of whose table index is a unique enumeration value representing a physical input.

The logical output PVID set may incorporate one or more logical output PVIDs representing one or more output signals, respectively. The logical output map may incorporate one or more values which are unique physical output enumeration values corresponding to the one or more physical output PVIDs, respectively. The physical outputs table may incorporate one or more physical output PVIDs, each of whose table index is a unique enumeration value representing a physical output.

When the controller reads a logical input, a read request may be routed through the logical input map to get data from a desired input terminal. When the controller writes to a logical output, a write request may be routed through the logical output map to reach a desired output terminal.

The controller may incorporate M input terminals and N output terminals. M may be an integer equal to or more than one. N may be an integer equal to or more than one. The one or more values of the logical input map, corresponding to the one or more physical input PVIDs, respectively, being changeable by the user may permit the user to assign or change an assignment of virtually any individual input terminal of one or more of M input terminals of the controller to receive a desired type of input signal. The one or more values of the logical output map, corresponding to the one or more physical output PVIDs, respectively, being changeable by the user may permits the user to assign or change an assignment of virtually any individual output terminal of one or more of N output terminals of the controller to send a desired type of output signal.

The logical input PVID set incorporating one or more logical input PVIDs representing one or more input parameters, respectively, may be unchangeable by the user. The physical inputs table incorporating one or more physical input PVIDs corresponding to one or more physical inputs, respectively, and defining the unique physical input enumeration values, respectively, may be unchangeable by the user.

The logical output PVID set incorporating one or more logical output PVIDs representing one or more output signals, respectively, may be unchangeable by the user. The physical outputs table incorporating one or more physical output PVIDs corresponding to one or more physical outputs, respectively, and defining the unique physical output enumeration values, respectively, may be unchangeable by the user.

The following patent documents may be relevant. U.S. Pat. No. 8,224,888, issued Jul. 17, 2012, and entitled “Public Variable Interface System”, is hereby incorporated by reference. U.S. patent application Ser. No. 13/071,092, filed Mar. 24, 2011, and entitled “Configurable HVAC Controller Terminal Labeling”, is hereby incorporated by reference.

In the present specification, some of the matter may be of a hypothetical or prophetic nature although stated in another manner or tense.

Although the present system and/or approach has been described with respect to at least one illustrative example, many variations and modifications will become apparent to those skilled in the art upon reading the specification. It is therefore the intention that the appended claims be interpreted as broadly as possible in view of the related art to include all such variations and modifications.

What is claimed is:

1. A heating, ventilation and air conditioning (HVAC) controller system having mappable inputs and outputs, comprising:
an HVAC controller;
a logical input set of one or more logical input public variable identifiers (PVIDs), each logical input PVID representing one or more parameters, respectively, and each PVID having an index;
a logical input map comprising a table of one or more values, each value corresponding to an index of a logical input PVID, respectively;
a physical inputs table comprising one or more physical input PVIDs, each physical input PVID represented by a unique physical input enumeration value that can be placed in the logical input map;
a logical output set of one or more logical output PVIDs, each logical output PVID representing one or more parameters, respectively, and each PVID having an index;
a logical output map comprising a table of one or more values, each value corresponding to an index of a logical output PVID, respectively; and
a physical outputs table comprising one or more physical output PVIDs, each physical output PVID represented by a unique physical output enumeration value that can be placed in the logical output map; and
wherein:
the sets, maps and/or tables are accessible by the HVAC controller;
the one or more values of the logical input map are changeable by a user via the controller; and
the one or more values of the logical output map are changeable by a user via the controller.

2. The system of claim 1, wherein:
a source of a logical input is an input terminal on the controller, a field of a network variable or an intermediate variable in a control application residing on the controller; and
a destination of a logical output is an output terminal on the controller, a field of a network variable or an intermediate variable in a control application residing on the controller.

3. The system of claim 1, wherein:
the set of one or more logical input PVIDs that represent one or more parameter inputs is fixed;
the one or more physical input PVIDs associated with the one or more physical inputs are fixed;
the set of the one or more logical output PVIDs that represent one or more output signals is fixed; and
the one or more physical output PVIDs associated with the one or more physical outputs are fixed.

4. A method for providing a controller system having mappable inputs and outputs, comprising:
developing a logical input set of one or more logical input public variable identifiers (PVIDs) comprising one or more logical input PVIDs representing one or more input parameters, respectively;
developing a logical input map comprising one or more values corresponding to the one or more logical input PVIDs, respectively;
developing a physical inputs table comprising one or more physical input PVIDs, each with a unique physical input enumeration value suitable for placement in the logical input map;
providing a controller;
placing the logical input set, the logical input map and/or the physical inputs table into a memory of the controller; and
operating the controller to change, as desired, the one or more values of the logical input map corresponding to the one or more logical input PVIDs, respectively.

5. The method of claim 4, further comprising:
developing a logical output set of one or more logical output public variable identifiers (PVIDs) comprising one or more logical output PVIDs representing one or more output signals, respectively;
developing a logical output map comprising one or more values corresponding to the one or more logical output PVIDs, respectively;
developing a physical outputs table comprising one or more physical output PVIDs, each with a unique physical output enumeration value suitable for placement in the logical output map, respectively;
placing the logical output set, the logical output map and/or the physical outputs table into the memory of the controller; and
operating the controller to change, as desired, the one or more values of the logical output map corresponding to the one or more logical output PVIDs, respectively.

6. The method of claim 4, wherein the logical input set is unchangeable with respect to the one or more logical input PVIDs representing one or more input parameters.

7. The method of claim 5, wherein the logical output set is unchangeable with respect to the one or more logical output PVIDs representing one or more output parameters.

8. The method of claim 6, wherein the physical inputs table is unchangeable with respect to the one or more physical input PVIDs corresponding to the one or more values of the logical input map.

9. The method of claim 7, wherein the physical outputs table is unchangeable with respect to the one or more physical output PVIDs corresponding to the one or more values of the logical output map.

10. The method of claim 6, wherein:
the physical inputs table is set at a factory that produces the table; and
the logical input set is set at the factory that produces the set.

11. The method of claim 7, wherein:
the physical outputs table is set at a factory that produces the table; and
the logical output set is set at the factory that produces the set.

12. The method of claim 10, wherein the logical input map is capable of being changed after leaving the factory that produces the map.

13. The method of claim 11, wherein the logical output map is capable of being changed after leaving the factory that produces the map.

14. The method of claim 12, wherein operating the controller to change the one or more values of the logical input map relative to the corresponding one or more logical input PVIDs, respectively, is facilitated with a tool that provides a user plain language directions and/or options so as to change the one or more values of the logical input map corresponding to one or more logical input PVIDs, respectively.

15. The method of claim 13, wherein operating the controller to change the one or more values of the logical output map relative to the corresponding one or more logical output PVIDs, respectively, is facilitated with a tool that provides a user plain language directions and/or options so as to change the one or more values of the logical output map relative to the corresponding one or more logical output PVIDs, respectively.

16. A controller system having mappable inputs and outputs, comprising:
a logical input public variable identifier (PVID) set;
a logical input map associated with the logical input PVID set;
a physical inputs table associated with the logical input map and one or more physical inputs; and
a controller having a memory that incorporates the logical input PVID set, the logical input map and/or the physical inputs table; and
wherein one or more values of the logical input map, corresponding to one or more logical input PVIDs of the logical input PVID set, respectively, are changeable by a user.

17. The system of claim 16, further comprising:
a logical output PVID set;
a logical output map associated with the logical output PVID set; and
a physical outputs table associated with the logical output map and one or more physical outputs, respectively; and
wherein:
the memory incorporates the logical output PVID set, the logical output map and/or the physical outputs table; and
the one or more values of the logical output map, corresponding to one or more physical output PVIDs of the physical output map, respectively, are changeable by the user.

18. The system of claim 17, wherein:
the logical input PVID set comprises one or more logical input PVIDs representing one or more input parameters, respectively;
the logical input map comprises one or more unique physical input enumeration values corresponding to the one or more physical input PVIDs, respectively; and
the physical inputs table comprises one or more physical input PVIDs, each of whose table index is a unique enumeration value representing a physical input.

19. The system of claim 18, wherein:
the logical output PVID set comprises one or more logical output PVIDs representing one or more output signals, respectively;
the logical output map comprises one or more values which are unique physical output enumeration values corresponding to the one or more physical output PVIDs, respectively;
the physical outputs table comprises one or more physical output PVIDs, each of whose table index is a unique enumeration value representing a physical output.

20. The system of claim 19, wherein:
when the controller reads a logical input, a read request is routed through the logical input map to get data from a desired input terminal; and
when the controller writes to a logical output, a write request is routed through the logical output map to reach a desired output terminal.

21. The system of claim 17, wherein
the controller comprises M input terminals and N output terminals;
M is an integer equal to or more than one;
N is an integer equal to or more than one;
the one or more values of the logical input map, corresponding to the one or more physical input PVIDs, respectively, being changeable by the user permits the user to assign or change an assignment of virtually any individual input terminal of one or more of M input terminals of the controller to receive a desired type of input signal; and
the one or more values of the logical output map, corresponding to the one or more physical output PVIDs, respectively, being changeable by the user permits the user to assign or change an assignment of virtually any individual output terminal of one or more of N output terminals of the controller to send a desired type of output signal.

22. The system of claim 16, wherein:
the logical input PVID set comprising one or more logical input PVIDs representing one or more input parameters, respectively, is unchangeable by the user; and
the physical inputs table comprising one or more physical input PVIDs corresponding to one or more physical inputs, respectively, and defining the unique physical input enumeration values, respectively, is unchangeable by the user.

23. The system of claim 17, wherein:
the logical output PVID set comprising one or more logical output PVIDs representing one or more output signals, respectively, is unchangeable by the user; and
the physical outputs table comprising one or more physical output PVIDs corresponding to one or more physical outputs, respectively, and defining the unique physical output enumeration values, respectively, is unchangeable by the user.
